(19) United States
(12) Patent Application Publication
(10) Pub. No.: US 2022/0074522 A1
(43) Pub. Date: Mar. 10, 2022

(54) Ring and Hook Wire Management System

(71) Applicant: BDG Innovations, LLC, Sacramento, CA (US)

(72) Inventors: David Stubben, Fair Oaks, CA (US); Brent Iseman, Pleasanton, CA (US); Larry DeVore, Rocklin, CA (US); Randall Ross, Tulare, CA (US)

(21) Appl. No.: 17/016,135

(22) Filed: Sep. 9, 2020

(51) Int. Cl. F16L 3/14; F16L 3/12

(52) U.S. Cl. CPC F16L 3/14; F16L 3/1218

(57) ABSTRACT

A cable management hanger for securely hanging at least one cable on a module structure, wherein the cable management hanger includes a ring member, a hook and a neck transition portion. The ring member is adaptable to hang at least one cable therethrough. The hook includes a tip and a neck member. The tip is connected with the module structure. The neck transition portion is connected with the hook and the ring member. The neck transition portion and the neck member affect the center of gravity thereby enabling the cable management hanger to support the at least one cable and to hang on the module structure.

### BACKGROUND OF THE DISCLOSURE

### Technical Field of the Disclosure

The present invention relates generally to apparatuses and methods for managing cables, and more particularly, to a method for managing cables utilizing a cable management hanger that securely hangs the cables on a module structure.

### Description of the Related Art

Cable management is a serious safety concern across many industries. Electrical or optical cables can easily become tangled or loose, which may lead to electrical shorts, trip hazards and a disorganized appearance. Cluttered cables may become easily damaged, which in turn leads to subsequent cable maintenance. Various types of cables are used in industries for power transmission, networking and communication. Similarly, construction sites use several cable systems for powering different types of equipment. The presence of electrical cables in construction sites increases the safety concern. Therefore, an efficient cable management system for securely handling various cable systems is necessary for many reasons.

Several systems have been developed to alleviate the problems associated with cable management. One such system describes a portable cable management device having various attachment mechanisms adapted for securing the device to various surfaces and structures including an I-beam flange attachment mechanism.

Another system for cable management describes a one-piece hanger for supporting objects on a wall. The hanger may include a spring wire element having a straight shank portion which connects a front hook portion with a rear locking portion. The hanger is substantially irreversibly locked in the wall so that rotation relative to the wall is prevented. This hanger requires several components for irreversibly locking in the wall which increases the maintenance cost and provides a complex structure to the hanger. Further, it may be difficult to unlock the hanger from the wall after installation.

Therefore, there is a need for an efficient, cost effective and reliable device for managing cables. Furthermore, such a device would be designed to support cables with heavy weight. Such a device would require a minimum number of components for installation and would be light weight. Moreover, such a device would be created utilizing corrosion resistive material. Such a device would not be damaged from any movement of the object to which the device would be secured. Moreover, such a device would organize the cables in a steady manner thereby minimizing trip hazards. The present embodiment overcomes shortcomings in the field by accomplishing these critical objectives.

### SUMMARY OF THE INVENTION

To minimize the limitations found in the prior art, and to minimize other limitations that will be apparent upon the reading of the specification, the present disclosure provides a cable management hanger for securely hanging at least one cable on a module structure. The cable management hanger includes a ring member, a hook and a neck transition portion. The ring member includes a loop section and a relaxed ring open portion with an increased radius. The loop section is adaptable to hang the least one cable therethrough. The hook includes a tip and a neck member. The tip is inserted through a hole on a structure for hanging the cable management hanger thereon. The structure is an object to which the cable management hanger is secured and is related to industries, including but not limited to solar, mining, electrical, tunneling and utility. In the case of the solar industry, the modular structure is a solar module frame or solar module support structure.

The cable management hanger comprises a neck member having a bent structure that provides a symmetrically offset center of gravity, thereby allowing the cable to hang through the loop section and distance the cable from the object from which the hanger is hung. The neck transition portion is connected to the hook and the ring member. The neck transition portion allows the center of gravity to be moved closer to a middle portion or preferably exactly to the middle of the ring member thereby providing proper balance to the ring member for supporting the at least one cable thereon. The hook is at an angular configuration with respect to the ring member. In the preferred embodiment, the angular configuration between the hook and the ring member is 90 degrees. In another configuration, the angular configuration between the hook and the ring member is zero degrees, and in yet another configuration, the angular configuration between the hook and the ring member is 45 degrees. Other configurations at angles between these provided angles are possible, and these three different angular configurations of the cable management hanger contemplated here make it applicable to different application fields for managing the cables.

The preferred embodiment includes a method for managing the at least one cable utilizing the cable management hanger. The method commences by providing the cable management hanger. Next, the hole is provided on the module structure. Then, the cable management hanger is hung on the module structure by inserting the tip through the hole. Thereafter, the at least one cable is inserted through the loop section of the ring member. Upon inserting the cable, the hook and the neck transition portion are enabled to affect the center of gravity thereby allowing the ring member to support the at least one cable hanging therethrough.

In the case of solar industry, there is often the requirement for a tracking system where the solar modules tilt throughout the day. The long neck member allows the center of gravity to keep the cables hanging safely as the solar modules tilt throughout the day to track the moving sun. The preferred shape of the cable management hanger allows it to twist 30-45 degrees (preferably 45) after it is resting in the hole and this twisting allows the user to rotate the hanger sufficiently to allow the cables to be slipped into the ring member.

It is a first objective of the present invention to provide a cable management hanger for securely hanging at least one cable on a module structure.

A second objective of the present invention is to provide a cable management hanger requiring a minimum number of components for installation.

A third objective of the present invention is to provide a cable management hanger that avoids damage and provides space for cables as module structure moves and tilts to track the sun throughout the day.

A fourth objective of the present invention is to provide a cable management hanger that can be easily attached or disconnected from a surface or object to which the hanger is hung.

Another objective of the present invention is to provide a cable management hanger adaptable to organize the cables in a tight and secure manner thereby minimizing trip hazards.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus, the drawings are generalized in form in the interest of clarity and conciseness.

FIGS. 1A-1D show perspective views of a cable management hanger for supporting at least one cable in accordance with the preferred embodiment of the present invention;

FIG. 2 is a front perspective view of the cable management hanger, illustrating a ring member of the cable management hanger in accordance with the preferred embodiment of the present invention;

FIG. 3 is a side perspective view of the cable management hanger, illustrating the ring member, a hook and a neck transition portion of the cable management hanger in accordance with the preferred embodiment of the present invention;

FIG. 4 is a perspective view of an array of solar modules installed with several cable management hangers in accordance with the preferred embodiment of the present invention;

FIG. 5A-B are perspective views of the cable management hanger, illustrating the hook and the ring member in 90-degree angular configuration in accordance with the preferred embodiment of the present invention;

FIG. 6 shows a perspective view of the cable management hanger installed on a solar support structure in accordance with the preferred embodiment of the present invention;

FIGS. 7A-7D show perspective views of the cable management hanger, illustrating the hook and the ring member in a zero-degree angular configuration in accordance with one embodiment of the present invention;

FIGS. 8A-8D show perspective views of the cable management hanger, illustrating the hook and the ring member in a 45-degree angular configuration in accordance with another embodiment of the present invention;

FIG. 9 is a perspective view of the cable management hanger, illustrating the at least one cable being inserted through the ring member where the hook and the ring member are in the 90-degree angular configuration in accordance with the preferred embodiment of the present invention;

FIG. 10 is a perspective view of the cable management hanger, illustrating the at least one cable being inserted through the ring member where the hook and the ring member are in the zero-degree angular configuration in accordance with one embodiment of the present invention; and

FIG. 11 is a perspective view of the cable management hanger, illustrating the at least one cable being inserted through the ring member where the hook and the ring member are in the 45-degree angular configuration in accordance with another embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

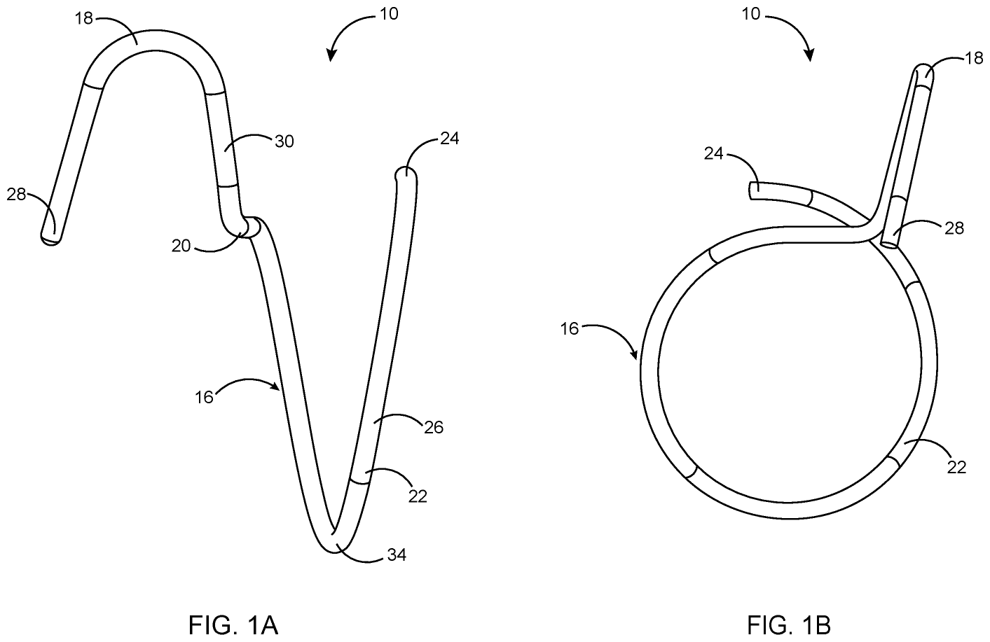

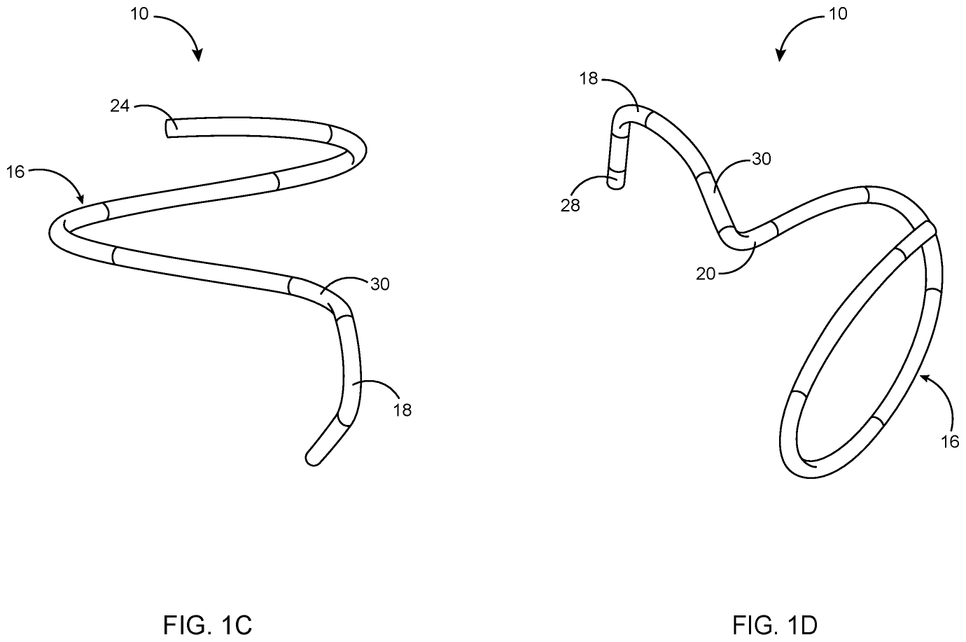

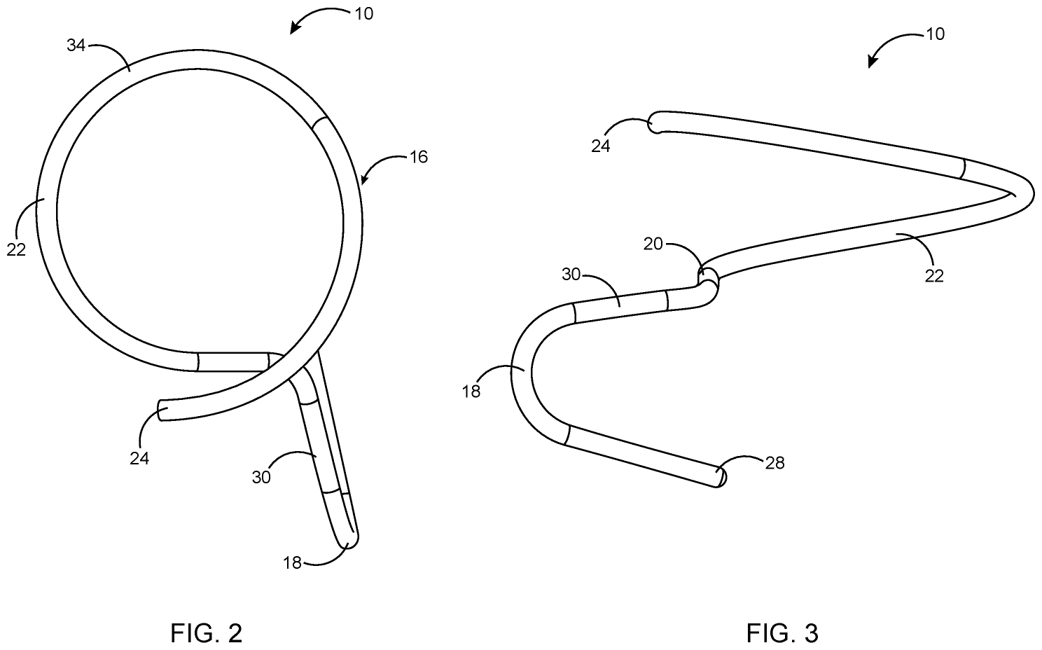

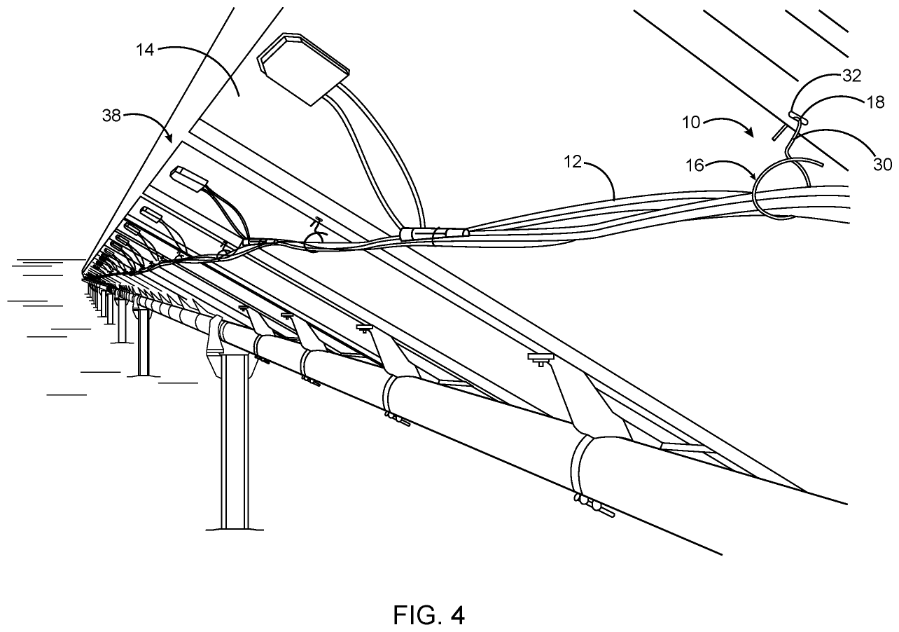

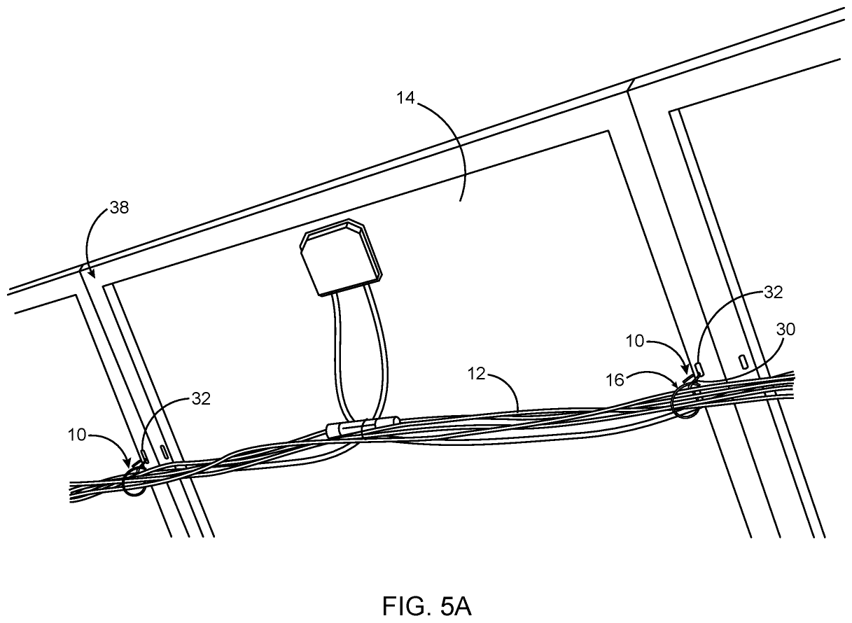

Referring to FIGS. 1A-1D, a cable management hanger 10 for securely hanging at least one cable 12 (see FIG. 4) on a module structure 14 (see FIG. 4) is illustrated. The cable management hanger 10 includes a ring member 16, a hook 18 and a neck transition portion 20. The ring member 16 includes a loop section 22 and a relaxed ring open portion 24 with an increasing radius as shown in FIG. 2. The loop section 22 is adaptable to hang the least one cable 12 therethrough and is positioned at a bottom end portion 26 of the cable management hanger 10. The module structure 14 is an object to which the cable management hanger 10 is secured and is related to industries, including but not limited to solar, mining, electrical, tunneling and utility. In the case of the solar industry, the module structure 14 is a solar module.

As shown in FIG. 3, the hook 18 includes a tip 28 and a neck member 30. The tip 28 is inserted through a hole 32 (see FIG. 4) on the module structure 14 for hanging the cable management hanger 10 thereon. Preferably, the neck member 30 has a bent structure that affects the center of gravity thereby allowing the cable 12 to hang through the loop section 22. The cable management hanger 10 can be easily disengaged from the module structure 14 by disconnecting the tip 28 from the hole 32.

The neck transition portion 20 is connected to the hook 18 and the ring member 16 as shown in FIGS. 1A-3. The neck transition portion 20 allows the center of gravity to be moved closer to a middle portion 34 or preferably exactly to the middle portion 34 of the ring member 16 thereby providing proper balance to the ring member 16 for supporting the at least one cable 12 thereon.

The hook 18 is at an angular configuration with the ring member 16. In the preferred embodiment, the angular configuration between the hook 18 and the ring member 16 is 90 degrees as shown in FIGS. 1A-1D.

The preferred embodiment includes a method for managing the at least one cable 12 utilizing the cable management hanger 10. The method commences by providing the cable management hanger 10. Next, the hole 32 on the module structure 14 is provided. Then, the cable management hanger 10 is hung on the module structure 14 by inserting the tip 28 through the hole 32. Thereafter, the at least one cable 12 is inserted through the loop section 22 of the ring member 16. Upon inserting the cable 12, the hook 18 and the neck transition portion 20 are enabled to affect the center of gravity thereby allowing the ring member 16 to support the at least one cable 12 hanging therethrough. The preferred shape of the cable management hanger 10 allows it to twist 30-45 degrees (preferably 45) after it is resting in the hole 32 and this twisting allows the user to rotate the hanger 10 enough to allow the cables 12 to be slipped into the ring member 16.

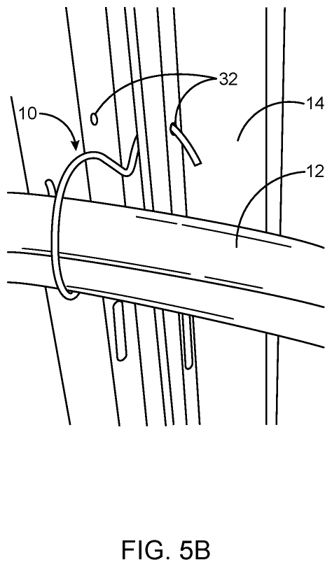

FIGS. 4-6 show the application of the cable management hanger 10 in the solar industry. In the solar industry, the cable management hanger 10 is installed in the solar module 14. Referring to FIGS. 4 and 5A-5B, the neck member 30 helps to move the ring member 16 away from the solar module 14 sufficiently, and allows the ring member 16 to have some space for the solar modules 14 to move and tilt over the course of a day as they track the moving sun. The diameter of the ring member 16 increases, which allows the ring member 16 to avoid looping back on itself. The user may set the tilting angle of the solar module 14 to any particular degree of inclination, and the cable management hanger will keep the cables spaced apart from the module. For instance, if the degree of inclination is 60, then these solar modules 14 tilt to about 60 degrees pointing east in the morning, and the solar modules 14 track the sun throughout the day until they are about 60 degrees pointing west in the afternoon. The long neck member 30 allows the center of gravity to keep the cables 12 hanging safely as the solar module 14 changes angle throughout the day.

As shown in FIGS. 4 and 5, the hook 18 and the ring number 16 are at a 90 degree angular configuration. Here, the cable management hanger 10 is installed in the underside of the solar module 14 where the hole 32 is perpendicular to the ground.

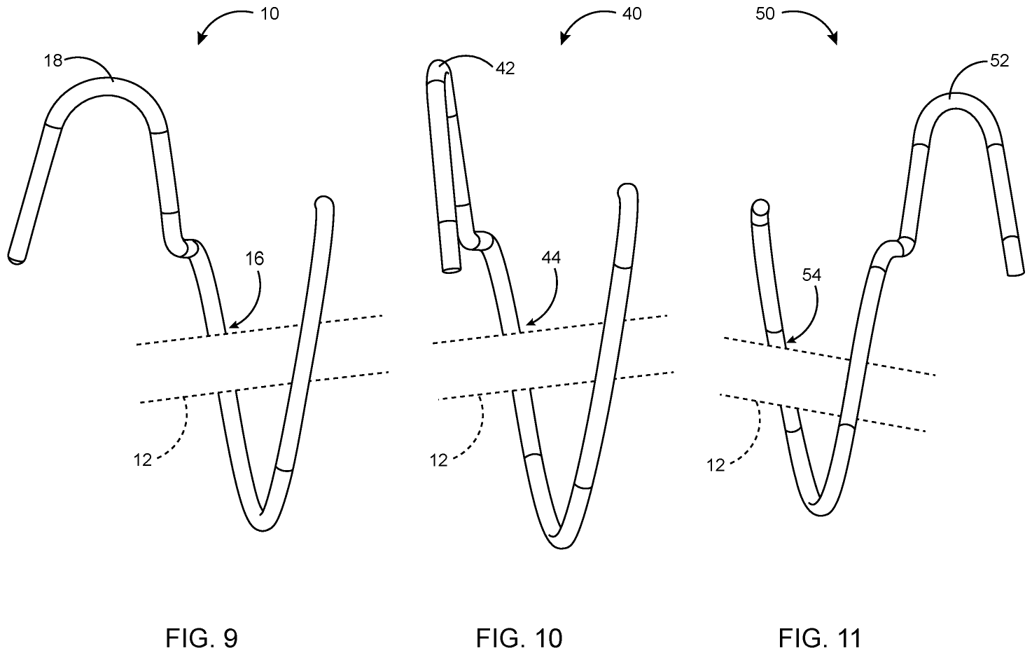

In the solar industry, there is a solar tracking system support structure 36 that connects to the solar array 38. In association with these components may be found cables 12, which connect to each solar module 14. Here, the hook 18 is inserted into the hole 32 in the solar module 14. The hole 32 may be in the plane either horizontal or vertical to the ground. Referring to FIG. 5B, the hook 18 is parallel/vertical with the ground, or said again, the hole 32 is through a vertical plane on the side of the solar module 14, the plane being perpendicular to the ground. The cable management hanger 10 shown in FIG. 5B is in a 90-degree configuration. FIG. 9 illustrates the cable 12 being inserted through the ring member 16 where the hook 18 and the ring member 16 are in the 90-degree angular configuration.

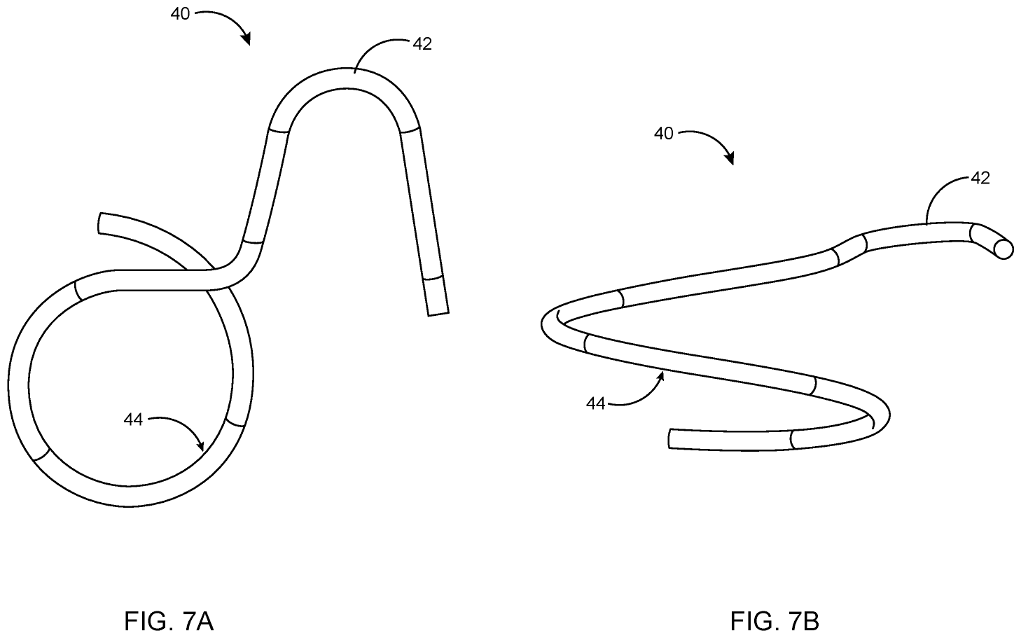

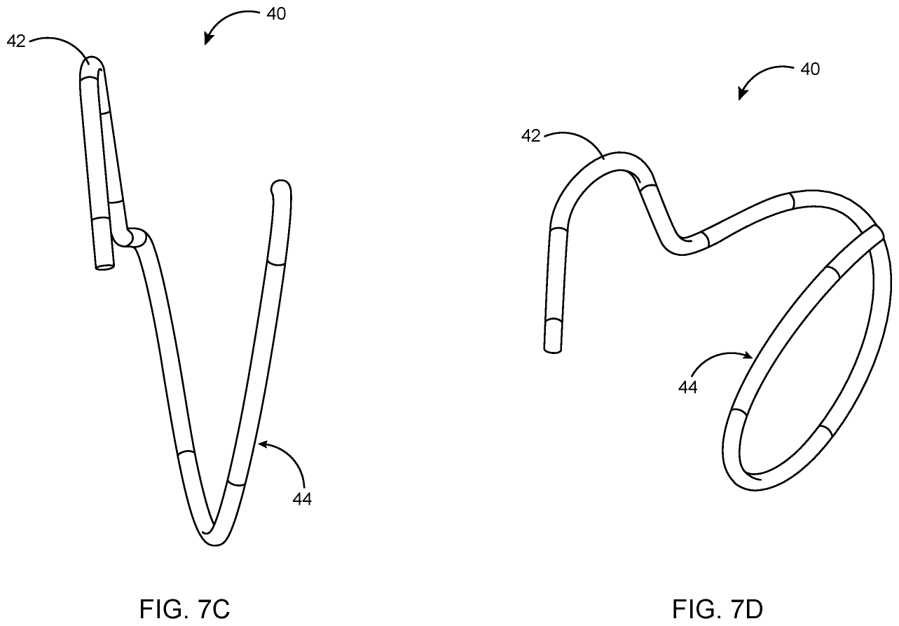

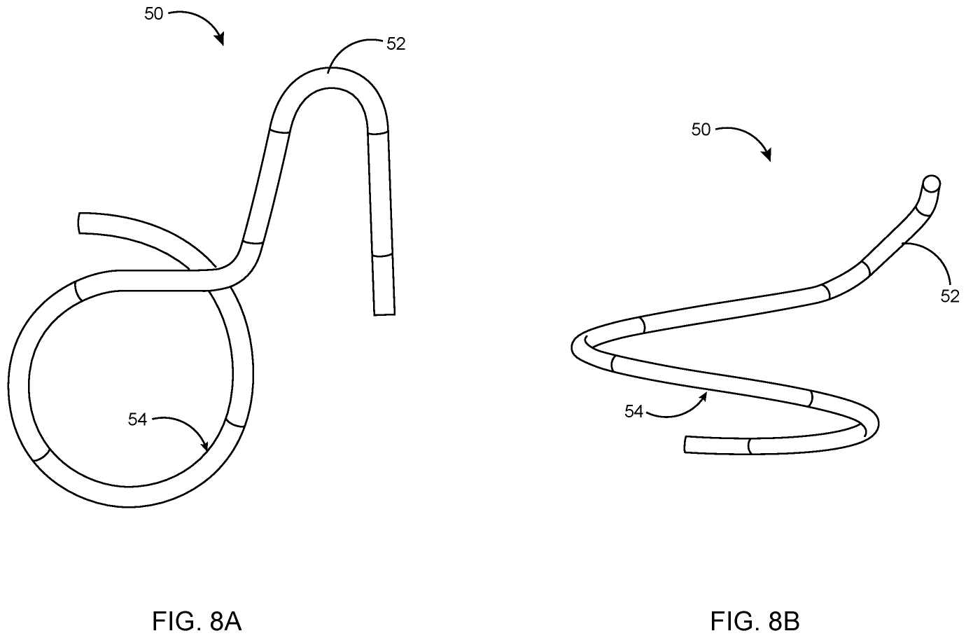

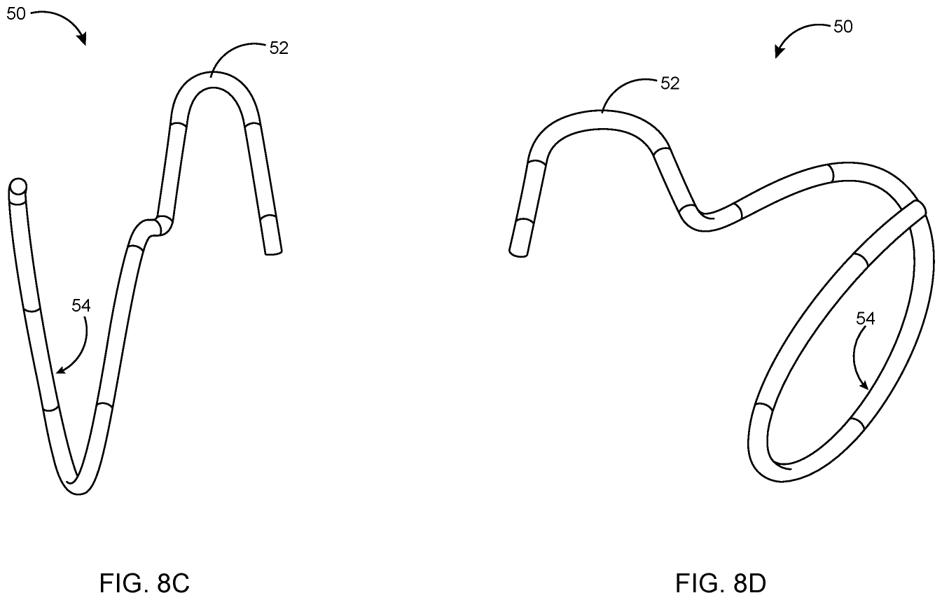

In one embodiment of the present invention, the hook 42 and the ring member 44 of the cable management hanger 40 are in a zero degree angular configuration as shown in FIGS. 7A-7D. FIG. 10 shows the cable 12 being inserted through the ring member 44 in the zero-degree angular configuration of the cable management hanger 40. In another embodiment of the cable management hanger 50 as shown in FIGS. 8A-8B, the angular configuration between the hook 52 and the ring member 54 is 45 degrees. FIG. 11 illustrates the cable 12 being inserted through the ring member 54 in the 45-degree angular configuration of the cable management hanger 50. The three different angular configurations of the cable management hanger 10 make it applicable to diverse application fields for supporting the cables. For each angular configuration of the cable management hanger 10, the size of the ring member 16 may vary. Three sizes of the ring member 16 are provided in the below Table 1. Preferably, a sample size of the ring member 16 of one and a quarter inches could manage 15 wires going through the loop section 22.

TABLE 1
Design Variants

| | Angle between hook | | | | | |
|---|---|---|---|---|---|---|
| | plane and wire ring | | | | | Approximately #10 |
| Ring | plane (Degrees) | | | Ring | | wires that fit in |
| Size | 0 | 45 | 90 | size | Area | loop section |
| | | | | 0.75 | 1.769063 | 5.4 |
| ¾″ | x | x | X | 1.25 | 4.914063 | 15 |
| 1¼″ | x | X | Preferred | 2.5 | 19.65625 | 60 |
| | | | Embodiment | | | |
| 2½″ | x | X | X | | 0 | 0 |

Preferably the cable management hanger 10 is constructed from stainless steel; however, the cable management hanger 10 may in some embodiments be composed of galvanized steel.

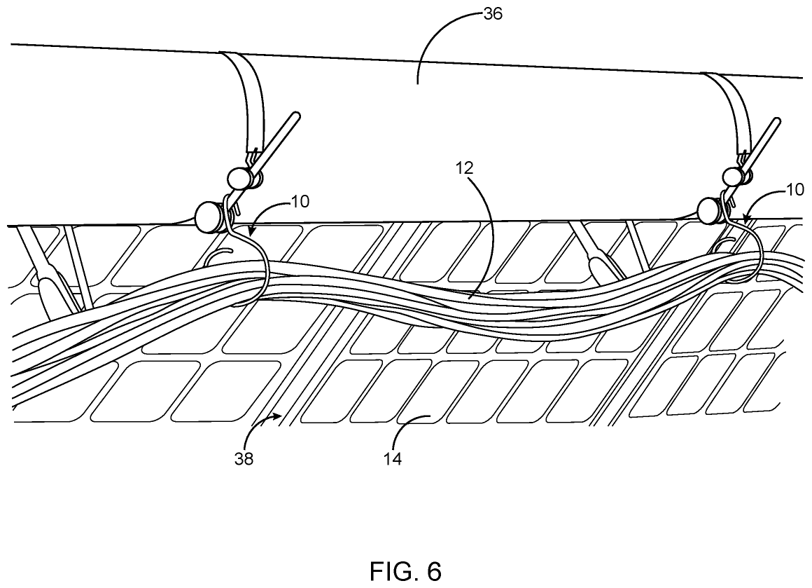

The cable management hanger 10 is made from extremely tough stainless steel and has superior corrosion resistance, thereby increasing plant design life. The hanger 10 is strong enough to support the weight of the cable 12 while maintaining neatness, and minimizes the need for both clip and zip ties which results in overall less material and effort. Further, the preferred cable management hanger 10 can be easily installed with one swift motion. The user is only required to loop the cable management hanger 10 around the cable 12 and then attach the hanger 10 to the module structure 14 in FIG. 5A or the torque tube 36 of the solar module support structure in FIG. 6.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention to not be limited by this detailed description, but by the claims and the equivalents to the claims appended hereto.

What is claimed is:

1. A cable management hanger comprises:
a ring member adaptable to hang at least one cable therethrough;
a hook having a tip and a neck member, the tip being connected to a module structure; and
a neck transition portion connected to the hook and the ring member, the neck transition portion and the neck member affecting the center of gravity such that the cable management hanger supports the at least one cable and to hang from the module structure;
wherein the ring member includes a loop section and a relaxed ring open portion having an increasing radius; and
is wherein the hook is at an angular configuration with respect to the ring member.

2. The cable management hanger of claim 1 wherein the loop section 22 is positioned at a bottom end portion of the cable management hanger.

3. The cable management hanger of claim 1 wherein the angular configuration between the hook and the ring member is 90 degrees.

4. The cable management hanger of claim 1 wherein the angular configuration between the hook and the ring member is 0 degrees.

5. The cable management hanger of claim 1 wherein the angular configuration between the hook and the ring member is 45 degrees.

6. The cable management hanger of claim 1 wherein the tip is inserted through a hole on the module structure for hanging the cable management hanger thereon.

7. The cable management hanger of claim 1 wherein the neck transition portion allows the center of gravity to be located at a middle portion of the ring member, thereby providing proper balance to the ring member for supporting the at least one cable.

8. The cable management hanger of claim 1 wherein the ring member is hanging from at least a portion of a solar array.

9. A cable management hanger, the hanger comprising:
a ring member having a loop section adaptable to hang at least one cable therethrough;
a hook at an angular configuration with respect to said ring member, the hook further having a neck member and a tip in connection with a module structure, the neck member creating a center of gravity enabling the at least one cable to hang through the ring member; and
a neck transition portion connected to the hook and the ring member, the neck transition portion allowing the center of gravity to be moved closer to a middle portion of the ring member, thereby providing proper balance to the ring member for supporting the at least one cable thereon;
whereby the hook and the neck transition portion enable the cable management hanger to manage the at least one cable and to hang on the module structure.

10. The cable management hanger of claim 9 wherein the angular configuration between the hook and the ring member is 90 degrees.

11. The cable management hanger of claim 9 wherein the angular configuration between the hook and the ring member is 0 degrees.

12. The cable management hanger of claim 9 wherein the angular configuration between the hook and the ring member is 45 degrees.

13. The cable management hanger of claim 9 wherein the tip is inserted through a hole on the module structure for hanging the cable management hanger thereon.

14. The cable management hanger of claim 9 wherein the ring member includes a relaxed ring open portion having an increased radius.

15. A method for managing at least one cable, the method comprising the steps of:
a) providing a cable management hanger having a ring member, a hook and a ring transition portion;
b) providing a hole on a module structure;
c) hanging the cable management hanger on the module structure by inserting the tip through the hole;
d) inserting the at least one cable through a loop section of the ring member; and
e) enabling the hook and the neck transition portion to affect the center of gravity thereby allowing the ring member to support the at least one cable hanging therethrough;
wherein the hook is at an angular configuration with respect to the ring member.

16. The method of claim 15 wherein the ring member includes a relaxed ring open portion having an increased radius.

17. The method of claim 15 wherein the angular configuration between the hook and the ring member is 90 degrees.

18. The method of claim 15 wherein the angular configuration between the hook and the ring member is 0 degrees.

19. The method of claim 15 wherein the angular configuration between the hook and the ring member is 45 degrees.
